(19) United States
(12) Patent Application Publication
(10) Pub. No.: US 2025/0193468 A1
(43) Pub. Date: Jun. 12, 2025

(54) SYSTEMS AND METHODS FOR MEDIA VERIFICATION, ORGANIZATION, SEARCH, AND EXCHANGE

(71) Applicant: Social Labs, LLC, Rocky Hill, CT (US)

(72) Inventors: Sahil Laul, Rocky Hill, CT (US); Sameer Laul, Rocky Hill, CT (US)

(73) Assignee: Social Labs, LLC, Rocky Hill, CT (US)

(21) Appl. No.: 19/059,656

(22) Filed: Feb. 21, 2025

Related U.S. Application Data
(63) Continuation of application No. 17/704,794, filed on Mar. 25, 2022.
(60) Provisional application No. 63/166,357, filed on Mar. 26, 2021.

(51) Int. Cl. H04N 21/258; G06F 16/78; G06F 16/787; G06F 21/16; H04N 21/23; H04N 21/858

(52) U.S. Cl. CPC H04N 21/25875; G06F 16/7867; G06F 16/787; G06F 21/16; H04N 21/23; H04N 21/858

(57) ABSTRACT

Systems and methods are disclosed herein for providing reliable, verified media content. Media content may be verified at the source, creator credentials vetted and associated with media content, and metadata for efficient organization, searching, and verification of content may be processed.

### RELATED APPLICATIONS

This application claims priority from U.S. patent application Ser. No. 17/704,794 filed Mar. 25, 2022, which in turn claims the benefit of U.S. Provisional Application No. 63/166,357 filed Mar. 26, 2021, the contents of which are incorporated by reference herein in their entirety.

### BACKGROUND OF THE INVENTION

This disclosure relates generally to distributed journalism and media. More particularly, this disclosure concerns media verification, organization, analysis, search, discovery, and reproduction.

Real-time, or near-real-time, video and media services are not capable of providing production-quality content quickly and consistently. User-generated content often has issues with fact-checking criteria such as originality, source, location, time, and motive. Current methods of user-generated content search and discovery are largely limited by an individual's network and this media is not easily accessible by the public and organizations that seek to use it. Journalism and news sources require high-quality content that may be verified and ethically reproduced quickly with little manpower.

### SUMMARY OF THE INVENTION

In one or more embodiments, the present disclosure provides a method and system for providing a verified media platform, comprising at least one creator device, at least one user device, and a verified media server in network communication. The creator device is configured to execute a creator application and host a media oracle. The creator application provides creator credentials to the media oracle. A media source is captured through a camera application on the creator device. The media source and its identifiers including geolocation and timestamp, creator credentials, are processed automatically, by the mobile media oracle, into primary data and reproduction-centric metadata. The primary data and reproduction-centric metadata are combined into one or more verified media files. The verified media files are stored in the verified media server database. The verified media files are organized into sets of data stored on the verified media server according to its identifiers. The verified media files are transmitted to the user device. The verified media files are viewed in a list view or geo-map view on the user device. Sizzles are generated from a plurality of verified media files according to engagement metrics, and other AI-based methods concerning audio and motion activity within a content stream. Licenses are automatically provided by a verified media exchange when requested by an enterprise user.

The systems and methods disclosed herein will improve citizen awareness and news-quality user-generated content's time-to-production. A landmark study on user-generated content by Columbia University's Tow Center for Digital Journalism found that on average news stations use eleven pieces of user-generated content per day but face several fundamental challenges in obtaining and verifying this content. Furthermore, 72 percent of user-generated content found online is not labeled or described as user-generated content. Claire Wardle et al., Amateur Footage: A Global Study of User-Generated Content in TV and Online News (Columbia Journalism School, 2017). This disclosure provides for overcoming these fundamental challenges faced by news and media organizations by ensuring that there is trust between creators and user enterprises by using, among other techniques, advanced and automated verification processes, comprehensive watermarking and reproduction statistics, and new metadata cultivation.

### BRIEF DESCRIPTION OF THE DRAWINGS

FIG. 1 is an overview of the system elements and network.

FIG. 2 is a flowchart of the application when in the user application, the creator application, and the enterprise user application.

FIG. 3 is a schematic process diagram from creator login to media upload.

FIG. 4A is a first portion of illustrative flowchart of a media application's user navigation and features in accordance with some of the embodiments of this disclosure.

FIG. 4B is a second portion of illustrative flowchart of a media application's creator navigation and features in accordance with some of the embodiments of this disclosure.

FIG. 5 depicts an example landing page when embodied on a mobile device.

FIG. 6A is an illustrative embodiment of a filter and search page on a mobile device.

FIG. 6B is an illustrative embodiment of a filter and search page on a desktop or web browser application.

FIG. 7A shows one embodiment of a map search with hotspots and content thumbnails.

FIG. 7B shows an embodiment of a map search.

FIG. 8 illustrates a camera feature.

FIG. 9 is an overview of the verified media exchange operation model.

FIG. 10 is a schematic process diagram of a licensing protocol according to one or more of the embodiments of this disclosure.

FIG. 11 is an illustrative diagram concerning a media oracle and its operative qualities according to at least some embodiments of this disclosure.

FIG. 12 is an illustrative process diagram for the generation of mosaics and sizzles.

### DETAILED DESCRIPTION

The embodiments described herein provide systems and methods for/of media verification, organization, search, discovery, and exchange. Media, referred herein analogously with the term “content,” refers to any means of communication including audio, photo, video, vignette, text, and combinations thereof. The systems and methods disclosed improve the efficiency and reliability of digital media journalism and digital media distribution generally. As shown by recent global events, user-generated content has quickly become a driving force for awareness and change in the world. The world has seen the impact of previous-generation systems such as the 858.ma archive and its impact on the drive for political change. However, serious issues remain with the authenticity of user-generated content and the ability for distribution sources to quickly identify impactful and reliable user-generated content.

By implementing secure methods for creator credential verification and combining this information with advanced metadata generation techniques, reliable data is intuitively discoverable through modern searching methods and user interfaces. A fitting analogy for the application is that it creates a search engine for verified user-generated content (UGC), while also creating a collective, historical archive of primary source media. A user may search for specific titles relevant to the video names or descriptions, and filter content by date and inclusion/exclusion criteria. Additionally, the application acts as a marketplace, whereby UGC can be licensed by customers, or enterprise users that may have subscriptions to the platform.

The invention may be embodied in many different forms and should not be construed as limited to the embodiments set forth herein; rather these embodiments are provided so that this disclosure will be thorough and complete, and will fully convey the scope of the invention to those skilled in the art.

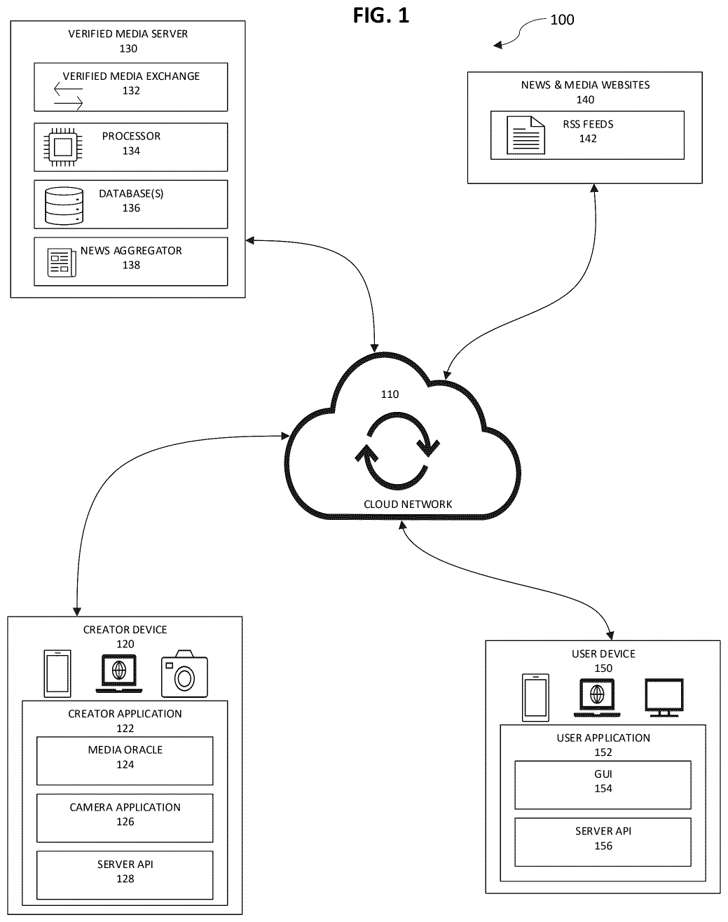

FIG. 1 depicts an exemplary system of elements for supporting a distributed, verified media platform. The five top-level elements shown in the exemplary embodiment are a cloud network 110, a creator device 120, a verified media server 130, news and media websites 140, and a user device 150. In this embodiment, the cloud network 110 is responsible for managing and routing communications between the creator device, verified media server, user device, and news and media websites. The creator device 120 is responsible for capturing content on a camera application 126, providing data necessary for verification via the media oracle 124, and transmitting data, via the server API 128 and cloud network 110, to the verified media server 130. The verified media server 130 hosts the verified media exchange 132 and news aggregator modules 138 and is comprised of one or more processor 134 and database nodes 136. In addition to the database nodes, which as known to those skilled in the art of electronic memory is preferred to be in the form of non-volatile memory (NVM), other forms of memory such as dynamic random access memory (DRAM) may be configured in the media server as an interim between the processor and database. News and media websites 140 are parsed by the news aggregator 138, which may include the use of RSS feeds 142, to provide third-party content relevant to proprietary content or user searches. Proprietary content and third-party content are viewed on the user device 150, through the user application 152, which contains a graphical user interface (GUI) 154 in communication with the verified media server 130 and verified media exchange 132 via the server API 156. This embodiment, and other embodiments, are discussed in more detail below.

As those experienced in the art of cloud computing and networking understand, communication with the cloud network 110 may be accomplished through the use of an internet service provider (ISP) network, wide area network (WAN), and various subnetworks that may be in the form of a local area network (LAN) or IP multimedia subsystem (IMS) network.

The creator device 120 may be configured to host a creator application 122, a media oracle 124, a camera application 126, and a server API 128. It should be noted that a creator device 120 and a user device 150 may consist of the same hardware executing different containers of one or more applications. The creator device may be in the form of a smartphone, smart camera, or other camera-outfitted transportable device such as a laptop. In the preferred embodiment, the creator device will be capable of providing an operating system that provides for the execution of a creator application 122. The creator application 122 may host a media oracle 124, a camera application 126, and a server API 128. The preferred embodiment is for the camera application 126 to be hosted within the creator application 122 so that content can be verified as original and unedited. Other embodiments of the system may provide for the upload of user-generated content (UGC) to the creator application captured outside of the camera application. The media oracle 124 provides for the full verification of content captured on the creator-application-hosted camera application 126, and to a lesser degree the media oracle 124 provides for the verification of content uploaded to the creator application dependent on the metadata available and the creator's profile and inputs. As those familiar with the art of digital encoding understand, current standards for file types such as video .MP4, .MOV, and .WEBM do not provide sufficient metadata necessary for quick analysis of content files to determine whether content is reliable enough for reproduction. Additionally, metadata inherent to the filetypes that are prolific for storage of user-generated content (UGC) today is often not easily inspectable to those without specialized computer software or who are not technically proficient. The media oracle 124, as fully enabled when coupled with the camera application 126 when hosted on the creator application 122, provides for a proprietary metadata form specific to user generated content that enables the verification of unaltered media by, among other information, computing a hash value of the media file after capture and encrypting it within the media file itself or generating a metadata file. Other information accessible in the metadata file may include time, date, geolocation, title, description, copyright, event, hash tags, artist or creator, language, publisher, quality, and other information. Combined, the hash value and metadata, referred to herein as “reproduction-centric metadata,” which may be provided in the same file or block of data, and may be provided within the media file itself, such as raw video herein referred to as “primary data,” provide for verification of authenticity and source of user-generated content. This primary data and/or reproduction-centric metadata may be stored on a blockchain to add an additional layer of authentication and provenance of both the content and its context. The reproduction-centric metadata may be transformed into the form of a watermark, which may or may not be machine-readable, such as a QR code. The reproduction-centric metadata may be transformed into a standardized, human-readable certificate.

The verified media server 130 is responsible for storing and retrieving content in one or more databases 136 and enabling communications between the creator device 120 and user device 150 through the cloud network 110. The verified media server 130, by one or more processors 134, sorts content received from the creator device 120, by the server API 128, according to its reproduction-centric metadata or other identifying information provided by the media oracle 124. The verified media server provides for a data organization structure, accessible to a plurality of users, by providing sets of folders configurable based on input received by a user device 150 and may include filters on any of the identifiers accessible in the reproduction-centric metadata, or other identifiers, including time, date, location, creator or artist, tags, event, description, title, duration, quality, engagement and more. Some information, such as engagement information, may be processed by the verified media server 130, with input from the user application 122. For example, the verified user application 152 may provide engagement metrics such as content views, content view duration, and content licenses purchased to the verified media server 130 to update the database 136. Additionally, the verified media server may compute engagement statistics such as viewer retention and demographics. The verified media exchange 132 is communicably coupled with the creator application 122 and user application 152 through the server API 128, 156. The engagement metrics of a particular piece of content are accessible to creators of that piece of content but may or may not be viewable to users via the user application GUI 154. Enterprise users, who are provided the ability to license content from/through the verified media exchange 132, may have access to some or all engagement metrics available. The news aggregator 138 receives information corresponding to user search results from the user application 152 and is integrated with the verified media exchange 132 to provide relevant news stories from news and media websites 140 using RSS feeds 142 and other content sharing protocols. Those skilled in the art of really simple syndication (RSS) feeds understand that an RSS feed may provide up-to-date access to websites, online blogs and magazines, and other digital content. The RSS feed may be provided in conjunction with the proprietary content stored in the verified media server database 136 on the user application GUI 154.

The user device 150 is responsible for executing the user application 152, which provides for the searching and viewing of content on the GUI 154, content stored in the verified media server database 136, via the server API 156. The user application 152 may be configured based on the type of user, which may include standard users and/or enterprise users. The user application 152 may be accessed by creators. In addition to basic search and viewing privileges, enterprise users may have access to the licensing module of the verified media exchange 132 and may be provided increased permissions to view reproduction-centric metadata and engagement information, including certificates and watermarks. The graphical user interface (GUI) 154 provided by the user application 152 processes and displays the content stored in the verified media server database 136 in multiple forms. Forms for processing and displaying of content on the GUI 154 include geo-maps with overlays and more traditional cascading file folder formats and list views. The GUI 154 may display a landing page, or discover page, of content based on either trends, such as trending hashtags, or other identifiers, or display content based on individual engagement criteria. The GUI 154 may display content based on individual search or filter parameters or stored user preferences. The server API 156 is responsible for providing communication protocol via the cloud network 110 to the verified media server 130.

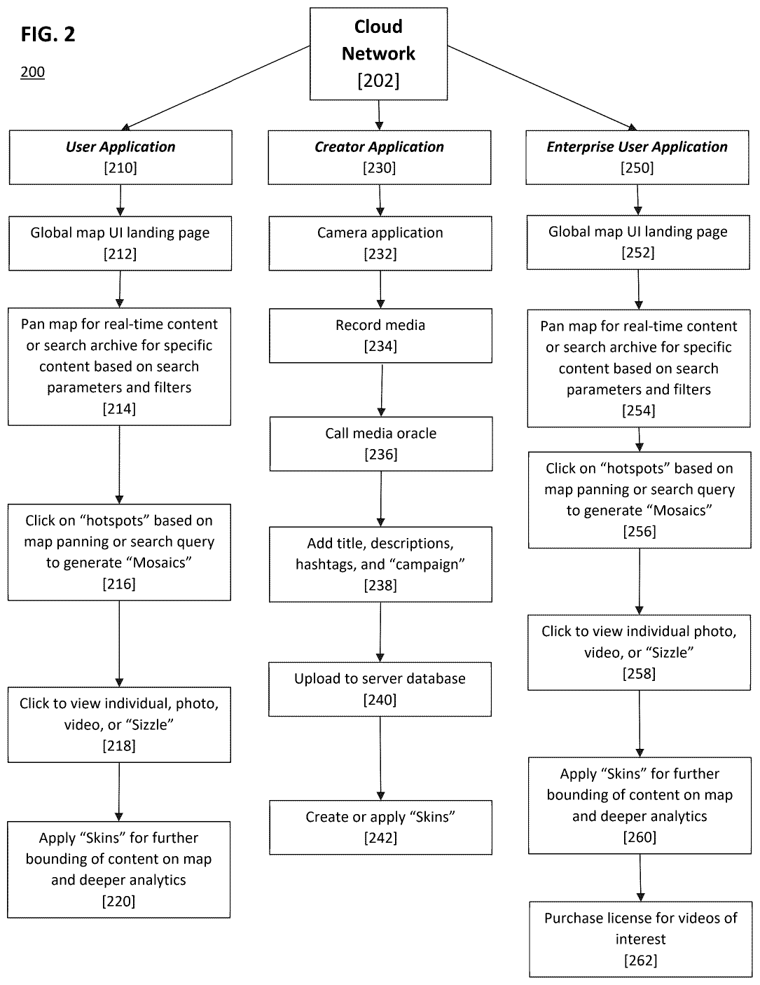

FIG. 2 is an illustrative flowchart showing how a user application 210, creator application 230, and enterprise user application 250 may function according to one embodiment. As previously provided, the user application, creator application, and enterprise user application may be hosted on the same hardware depending on the permissions of a particular user. User and creator hardware may be comprised of smartphones, smart cameras, and other mobile hardware with camera, microphone, and/or GPS inputs such as a laptop. The user application, after login, may default to a landing page 212. From the landing page, users can select and pan a geo-map for real-time content or enter a list/folder search of the verified media server database 214. Media may be accessed by selecting “hotspots” on the map, or through a search query or navigation of the verified media server database 216. The user application may generate “mosaics” of content corresponding to a hotspot area or that fit the instant search criteria 216. Mosaics are a collection of videos or content generated based on search parameters such as tags, date, time, location, radius, creator, and other identifying information. Mosaics may be displayed in various forms, including list views (with or without thumbnails), a plurality of icon views, full-screen navigable collections, or scrollable reels. Thumbnails and icons for content may be generated and displayed according to the engagement information. For example, a thumbnail, icon, or full-screen player may default to the portion, or frame, of the media with the highest engagement. Engagement may be based on viewing durations and counts at particular time points within a content steam, and/or other AI-based methods which concern activity within a content stream such as audio activity or motion activity. From a mosaic or search collection, individual media files may be accessed, or users can access the “Sizzle” feature, which is a reel of media stitched together based on time, location, hashtag relevancy, and engagement through AI algorithms 218. The database search can be overlaid as a “skin” on the map for further bounding of content and deeper analytics 220. Skin overlays are map overlays, which may be configured through the use of mapping platforms such as ArcGIS technology, to allow users to visualize particular community stories in conjunction with other geographical and map-based information such as pandemic/disease burden, congressional districts, storm maps, and other bounding and map-based information.

In certain embodiments, users must be verified before access is granted to the creator application 230. Verification methods may rely on identifying information such as a creator's phone number, email, driver's license, IP address, organization ID, social security number, tax ID, or passport. Organization IDs may include identification such as press passes, cage codes, or other form of corporate/entity IDs such as employee badges or school IDs. The creator application may default, after login, to the camera application 232. The camera application records media 232, which as previously provided, may include audio, photo, video, vignette, and other data forms. The camera application, according to one embodiment, may have inputs from one or more cameras and microphones to provide for multiple views and audio streams. The multiple views may be comprised of a creator-facing visual stream and an event-facing visual stream, which may be referred to as front-and-back video. The front-and-back video may have audio provided by a microphone designed to only pick up a creator's speech and a microphone designed to pick up ambient noises and external speech. The camera application 232 is coupled to the geolocation subsystem, which may be comprised of GPS, IP address, or other cell tower and WiFi node-based location determination known to those skilled in the art of modern geolocation methods on mobile devices. After content is generated through the camera application 232, the media oracle 236 is called by the creator application 230. The media oracle 236 is responsible for parsing the creator verification information, which may be referred to herein as creator credentials, and other metadata available from the camera application such as geolocation and time, to create the reproduction-centric metadata. The media oracle 236 may automatically add a title, description, tags, “campaigns”, and other identifying material to the reproduction-centric metadata 238. In some embodiments, at least some of the description, tags, “campaigns,” and other identifying material may be configured based on user input. Tags may be comprised of hashtags to be available within media captions and media players, or may be basic tags to be used as targets when searching and/or filtering the verified media server database. Once videos are uploaded to the verified media server database 240, the interactive map and database search features are updated so that the subject media may be discovered. The term interactive map should be considered interchangeable with geo-map, geo-map with hotspots, map, and map view. Skins may be created and/or applied 242 to content, which are open-source map overlays (through ArcGIS or other programs) that can create boundaries for videos such as counties, congressional districts, weather-affected areas, and other creative visualizations. Skins may be created and/or applied both before and after content is created in the creator application.

The enterprise user application functions largely the same as the user application and additionally provides for the purchasing of a license for reproduction of media 262. In some embodiments, the license may be comprised of a subscription to all or some of a particular creator's content, and may be termed in periods of months, years, or other time durations. Licenses may also be purchased for individual content, including a non-limited duration and/or non-limited reproduction quantity license. In some embodiments enterprise users also can view the reproduction-centric metadata, including time, location, creator credentials, user engagement information, and other metadata that may not be viewable to a non-enterprise user. Furthermore, license information may be combined or embedded in the machine-readable or human-readable certificate.

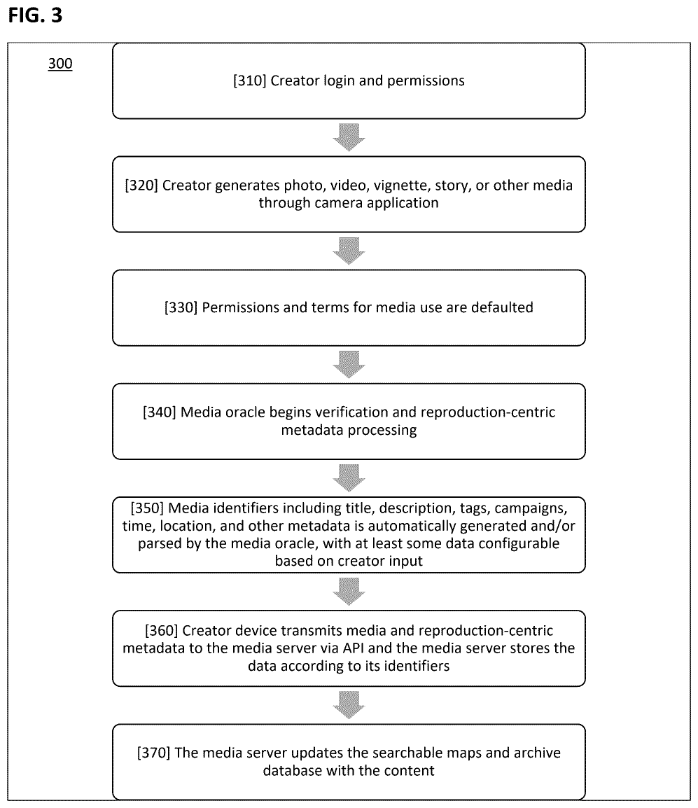

FIG. 3 is schematic flow diagram of an embodiment of a creator application beginning at creator login 310. At creator login 310, a username and password may be required, or other expedited login methods appreciated by those skilled in the art of application login methods, such as facial recognition, biometric recognition, maintained logins, and other expedited login methods. If a creator is logging in for the first time, the creator application will request permissions to access the camera and microphone hardware elements, which may include externally connected hardware elements or elements internal to a creator device. After hardware permissions are provided, creators may generate photos, videos, vignettes, stories, or other digital media forms through the camera application 320. Once media content is created, the creator application defaults permissions and terms for media use 330. The permissions and terms for media use may be provided by the verified media exchange previously discussed to provide for expedited licensure of creator-generated content. Creator-generated content, and user-generated content, are herein referred to synonymously. Also subsequent to content creation 320, the media oracle begins verification and processing of reproduction-centric metadata 340. As previously discussed, verification methods may rely on identifying information such as a creator's phone number, email, driver's license, IP address, organization ID, social security number, tax ID, or passport. Organization IDs may include identification such as press passes, cage codes, or other form of corporate/entity IDs such as employee badges or school IDs. The information acquired through the aforementioned verification methods is parsed by the media oracle and stored in the form of verified creator credentials that may be embedded into reproduction-centric metadata. The level of creator credentials available within the reproduction-centric metadata may be configurable based on creator permissions and a minimum standard for a creator's use of the creator application. Additional media content identifiers including title, description, tags, campaigns, time, location, and other metadata is automatically generated and/or parsed by the media oracle, with at least some data configurable based on creator input 350. For example, the media oracle may suggest or auto-populate non-absolute metadata including title, description, tags, or campaigns to be accepted, automatically in some embodiments, or configured by the creator. Absolute metadata, which according to the preferred embodiment is not editable by the creator, may include time, date, location, duration, creator credentials, and other information available to the creator application through the verification module of the media oracle, the creator device, and user application. After all media identifiers and reproduction-centric metadata is processed or configured, the creator device transmits the media file and reproduction-centric metadata in one or more files to the verified media server via the verified media server application programming interface (API) and the verified media server stores the data according to its identifiers in the verified media server database 360. Once the verified media server is updated with the creator-generated content, the searchable maps and database hosted on the verified media server are made available to the user application.

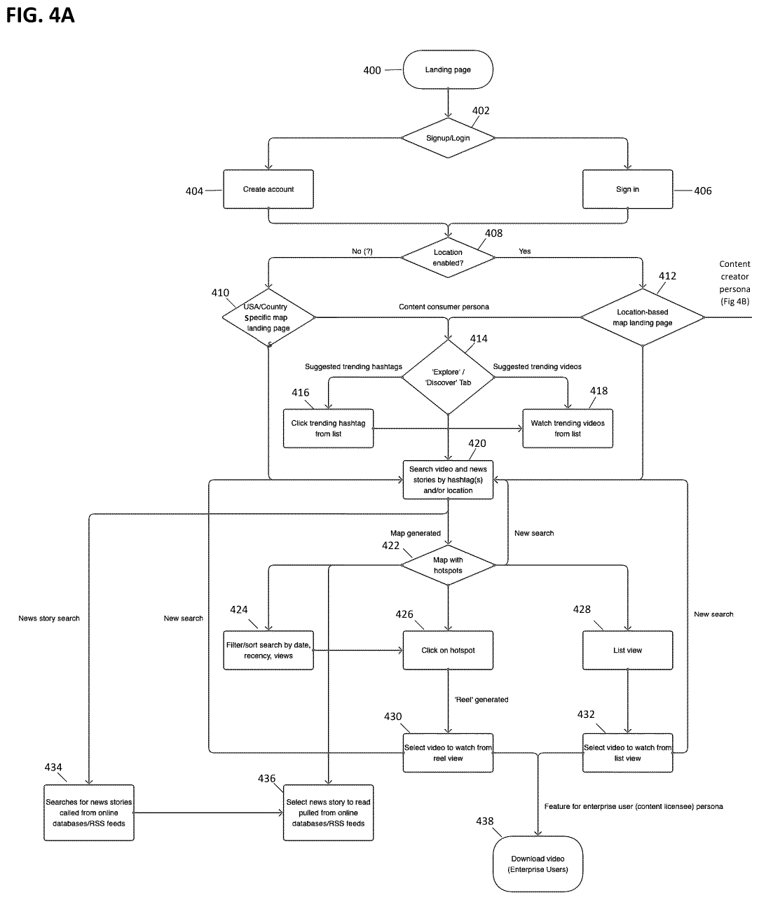

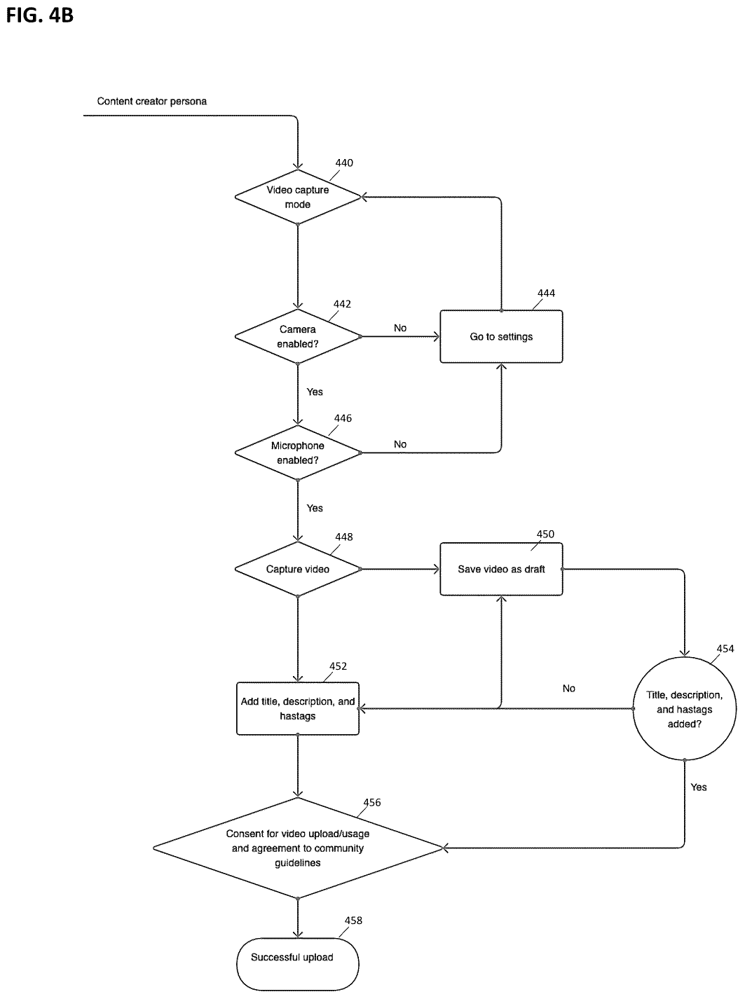

FIG. 4A is a schematic process diagram of an embodiment of a user application, including functions reserved for enterprise users. The user application may default to a landing page 400 that may require a user to sign up or login 402. Depending on whether a user has an active account, and their saved login preferences, a user may create an account 404 or sign in 406 from the landing page. As previously mentioned, in some embodiments, the landing page 400 may automate sign up and login 402 inputs and proceed directly to an application content page such as a country or static-location map landing page 410, a dynamic location-based map landing page 412, or an explore and discover tab 414. As described in this disclosure, the term tab may be used interchangeably with the term page, or a tab may refer to an element within a graphical user interface (GUI) designed to call forward and display some or all of a page window on the creator or user display, depending on the context of the term's use. Each time a user logs in, the user application determines whether location is enabled and available 408. Depending on whether location is enabled and available, the map landing page is either a static-location map landing page such as a country, state, or region landing page 410, or a dynamic location-based landing page 412 that may include user preferences such as range. According to one embodiment, and user preference, alternatively referred to as content consumer persona, the landing page may be provided in the form of an explore and discover page 414. The explore and discover page, or tab, may provide mosaics in the form of list views (with or without thumbnails), a plurality of icon views, or full-screen navigable collections. The default mosaics provided on the explore and discover tab are configurable based on a content consumer persona that is updated based on the type of media consumed by a particular user. Additionally, in some embodiments, a user may focus the explore and discover tag on content associated with trending hashtags based on user engagement 416. Further embodiments provide for the viewing of non-content-specific trending media or videos 418.

The user application search function begins at process 420 of FIG. 4A, wherein a user may search the verified media server database via a search bar or selectable identifiers. The search bar and selectable identifiers may filter media stored in the media database on any of the identifiers accessible in the reproduction-centric metadata, or otherwise available to the verified media server, including time, date, location, creator or artist, tags, event, description, title, duration, quality, and engagement. The result of the search process of 420, in one embodiment, will generate a geo-map with hotspots 422. Hotspots may be defined in one embodiment as an overlay in the form of a density-spectrum within a bounded area that is scaled based on the amount of user-generated content within the bounded area. The bounded area may be configured to size based on a specific range from the user device location or cursor reference point, or a particular locale, event, or region. User-generated content within a particular locale, event, region, state, country, may be accessed through panning the map and accessing a particular hotspot, or directly searching for the above-referenced locations through the search bar or selectable identifiers, if available. In areas where user-generated content is limited, the range or size of a hotspot may be increased, or individual geo-located thumbnails, or other identifiers, corresponding to an individual piece of user generated content may be overlaid on the map for users to access the content. Additionally, in one embodiment, a list view of user-generated content (UGC) may be generated within a sub-window of the geo-map, the list view configured to list UGC within the bounds of the geo-map frame, or map view 428. Map view and geo-map, as previously mentioned, may be used interchangeably within this disclosure; however, it should be noted that the term map view more generally refers to the map window whereas the geo-map refers the data populating the map window. The geo-map may also be referred to as the interactive map. Interactive maps, and geo-maps, as known to those skilled in the art of digital mapping, may be defined as maps that allow zooming in and out, panning around, identifying specific features, and querying underlying data via third-party or proprietary databases, and generating reports and other means of using or visualizing select information. The list view 428, in some embodiments, may be configured to be displayed automatically within a sub-window of the geo-map after the search 420. Other embodiments of the user application may be configured such that the list view may be available as a full-screen window accessible via a graphical user interface selection key; or the list view may be the default view after the search 420. The user application may be configured to update the geo-map or list view recursively based on additional filters and search terms added after the initial search 424. The user application may also be configured to start a new search, whereby the previously selected search terms, filters, and other identifiers are erased. Once a user is finished refining their search, user-generated content may be accessed by clicking on a hotspot on the geo-map 426 or selecting a video from the list view 432. The use of the term clicking is used interchangeably with the term selecting, and in some references and embodiments, may depend on whether the user application is executed on a touch device or external cursor-controlled device. Enterprise users, after selecting a video or media content 430, 432, have the option to purchase a license and download the media file 438. The media file may include the reproduction-centric metadata in the form of a standardized, human-readable certificate or machine-readable certificate and may be embedded into the media file itself or provided as a separate file such that the enterprise user can verify the creator credentials and other data stored within the reproduction-centric metadata. Machine-readable certificates may include the use of QR code technology. In some embodiments, the human-readable certificate and/or machine-readable certificate may incorporate the licensing terms therein. Additionally, a watermark may be generated and overlaid on the media or video content, embedded or overlaid on the human-readable or machine-readable certificate, or embedded into the media file itself. When the watermark is overlaid on the media or video content, verification of the authenticity of the media reproduced outside of the user application may be provided by uploading the media to the user application. After media is uploaded to the user application, the verified media server may be called and configured to recognize the watermark on a particular image/video frame through image recognition techniques and reproduce the certificate corresponding to the media on the user application. The advantage of this technique is that if embedded metadata is lost through the use of screen-recording technology, the overlaid watermark may still be used to subsequently verify authenticity, creator credentials, and other information provided by the media oracle and embedded into the reproduction-centric metadata.

In addition to user-generated content that may either be captured through the camera application hosted inside the user application, or user-generated content that is captured on an external camera and uploaded to the user application, the geo-map 422 and list view 428, which as previously mentioned the list view may be a sub-window of the map view, may include user-selectable news stories 436. The news stories may be hosted within the verified media server or retrieved from external online databases and RSS feeds through methods familiar to those in the art of modern news aggregators 434. News stories may be directly accessed through a web-browser within the user application as provided in modern operating system software development kits (SDKs) such as Android® WebView, or through an external web-browser on the user device.

FIG. 4B is an illustrative flow diagram of a creator application, or content creator persona. The creator application may be a container within a larger application that also includes the user/enterprise user application. The creator application, according to one embodiment, begins with the video capture mode 440, wherein videos, photos, audio, or other forms of audio and visual frame media content may be generated. If a creator is logging in for the first time, the camera permissions 442, microphone permissions 446, location services, and other hardware element permissions may be required to be enabled through the creator hardware permission settings 444. Video, and other forms of content, may then be captured 448. After content is captured, it may be saved as a draft 450 or a creator may proceed to adding a title, description, tags, and other identifiers 452. A title, description, tags, and other identifiers may be prefilled or automatically produced by the media oracle 452. Once the content has the minimum identifiers necessary for upload to the verified media server 452, 454, which may be handled automatically by the media oracle, consent for content upload and usage and agreement to community guidelines may be required 456. In some embodiments, creator consent to community guidelines and usage terms may be handled during creator verification during account creation 404, or handled on a video-by-video basis. In some embodiments, the usage terms may include default or initial licensing terms available to enterprise users for a particular piece of content (video-by-video basis) or all content produced by a creator.

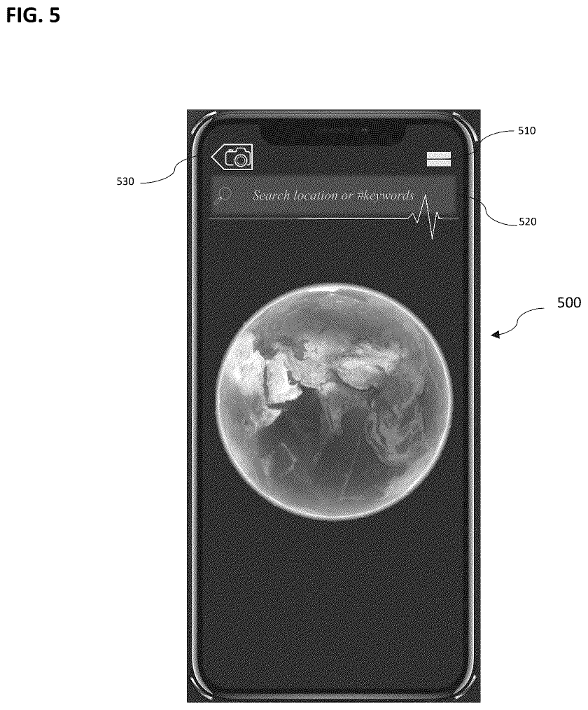

FIG. 5 displays a non-limiting example of an application landing page 500 when embodied on an iPhone. The landing page may contain a hamburger menu, or menu, button 510; a search bar 520; and a camera button 530. The camera button may only be accessible to creators, or users with the proper identity verification. Additionally, the main screen area, may default to a geo-map or list view at a user's current location or saved location.

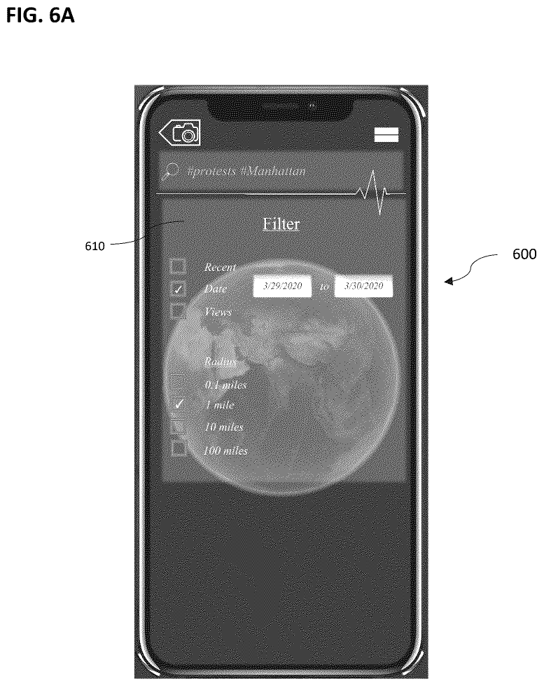

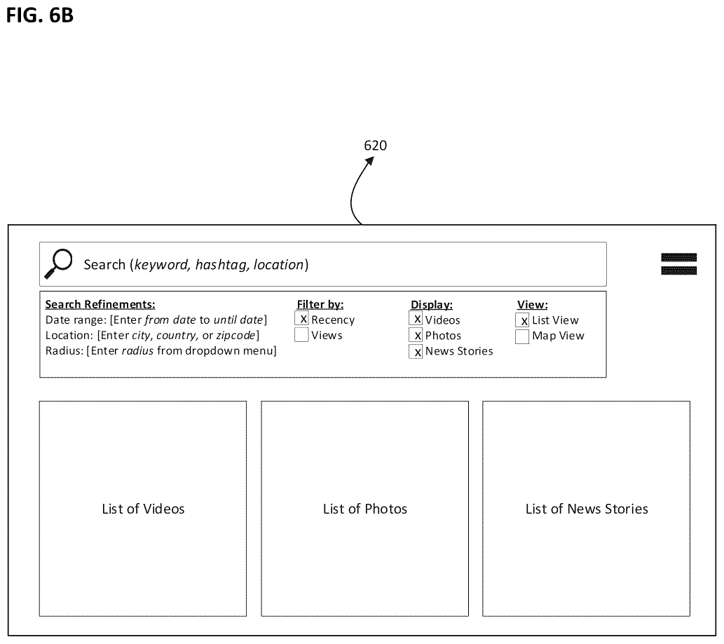

FIG. 6A is an illustrative example of a user application filter menu 610 embodied on an iPhone. In some embodiments the filter menu window may automatically open when a user selects the search bar, whereas in other embodiments the filter menu window may require user selection. The filters shown in FIG. 6A are non-exhaustive.

FIG. 6B is an illustrative example of a user application filter menu 620 embodied on a desktop application or browser-based application. In some embodiments, the search refinements, or filter window, may automatically be displayed on a search page, whereas in other embodiments the filter menu window may require user selection or automatically appear when a user selects the search bar. The filters shown in FIG. 6B are non-exhaustive.

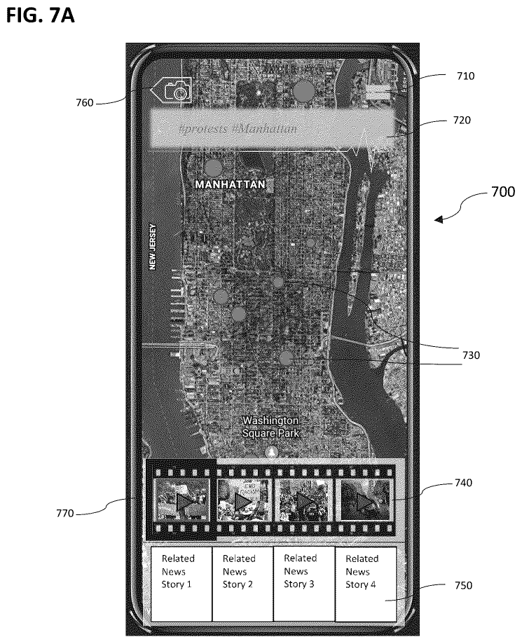

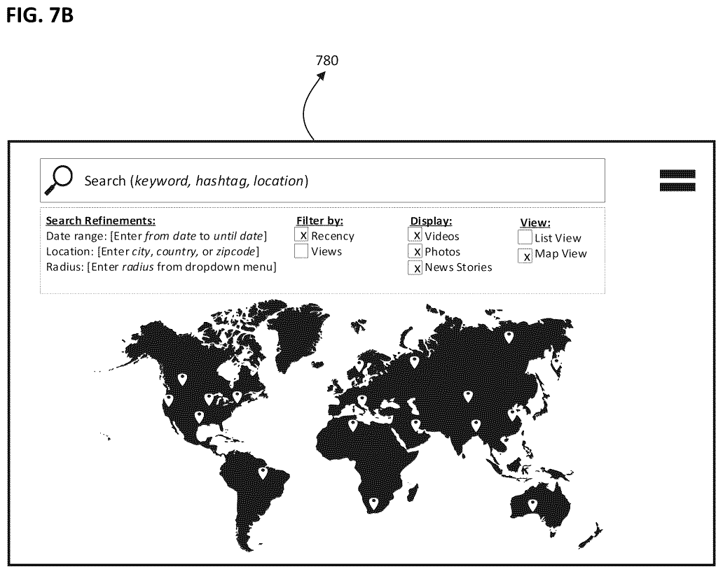

FIG. 7A illustrates an embodiment of a geo-map after a map search using the terms, or tags in some embodiments, ‘protests’ and ‘Manhattan’. As known to those experienced in the art of search strings, the search bar 720 may implement Boolean algebra and other logic between terms and characters. Hotspots in which target content is retrieved are shown as an overlay on the geo-map 730. FIG. 7A also illustrates an embodiment of the geo-map where the video list view window 740 and the relevant news story window 750 are active. Each window listed previously may be minimized or deselected using known methods of window control on touch or cursor-controlled devices. From the list view window, a sizzle generated by the media server may be generated and presented to the user 770. In some embodiments, sizzles may automatically be generated and presented after selection of a hotspot. Additionally, the hamburger menu 710 may include a list of available skins to be selected by the user.

FIG. 7B illustrates a desktop application or browser-based application embodiment of a geo-map populated with hotspots based on the recency filter; display filters: videos, photos, and news stories; and map view. In some embodiments, the hamburger menu may include a list of available skins to be selected by the user.

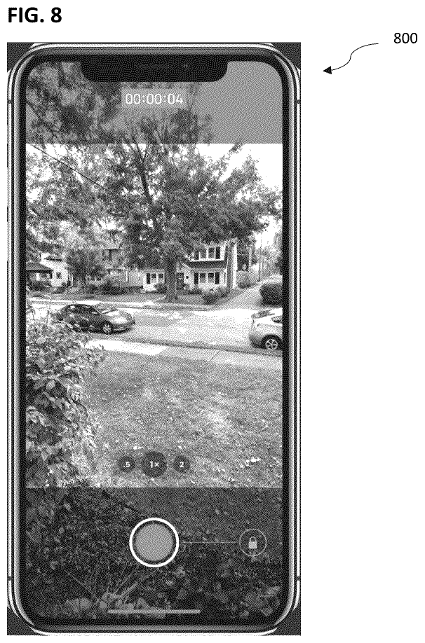

FIG. 8 illustrates a camera application as implemented on the iPhone when in the video mode. As known to those experienced in camera applications, controls may be provided for toggling recording, locking recording, adjusting zoom, and an active video timer may be displayed.

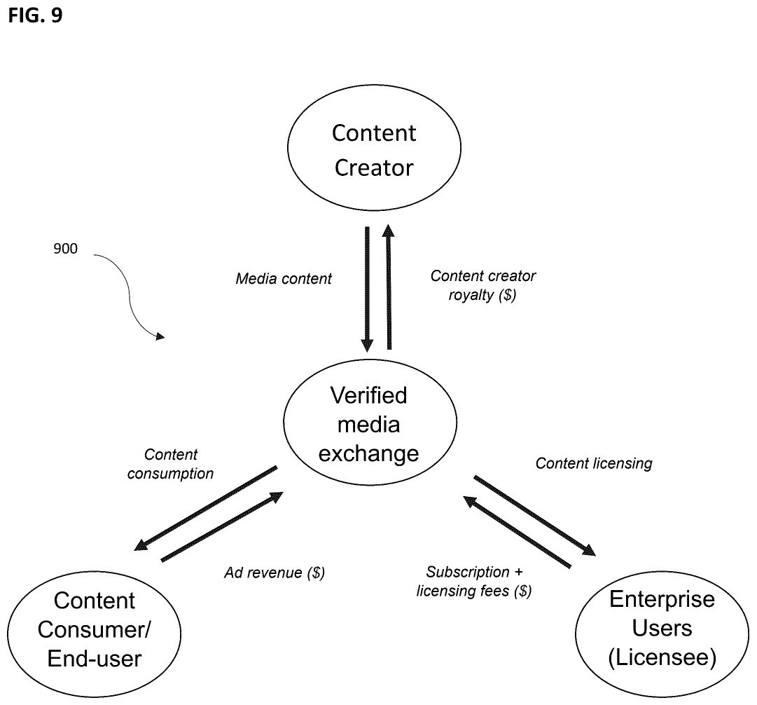

FIG. 9 is a schematic overview of an embodiment of a verified media exchange. The verified media exchange receives content from content creators and populates the verified media server database. Content creators receive royalties from content consumer ad revenue and subscription and licensing fees from enterprise users.

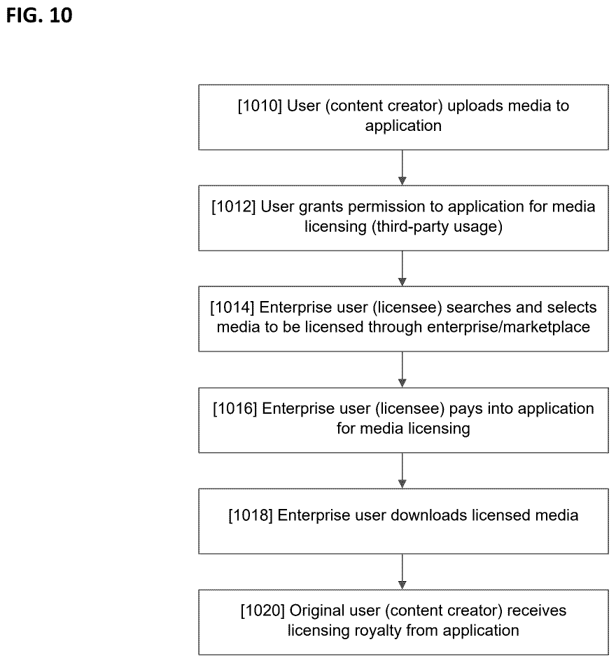

FIG. 10 is a schematic flow diagram of a licensing protocol implemented by the verified media exchange according to some embodiments. After a content creator uploads media to a user application and it is uploaded to a verified media server database 1010, the user is prompted to provide permissions for media licensing 1012 and may select from available pre-determined or pre-offered licensing terms. In some embodiments, the content may be bundled within a package license comprised of a subscription to all or some of a particular creator's content, wherein the subscription may be termed in periods of months, years, or other time durations. In other embodiments, licenses' terms may be set for individual content, including a non-limited duration and/or non-limited reproduction quantity license. In further embodiments, licenses' terms may be set for limited duration and/or limited reproduction. An example of a limited duration and limited reproduction license may include a license for a particular news broadcast event, or a license for a particular news broadcast segment for a specified duration. News broadcasts licenses may be further delineated by broadcast form including television/cable, news websites, or social media. Licenses for content to be embedded within digital news stories or columns may also employ the different license types specified above. An enterprise user may also include individuals that wish to license content. After an enterprise user selects a particular piece of content, or set of content to be licensed 1014, the enterprise user may accept the licensing terms set by the content creator or verified media exchange. In some embodiments, one of the default or selectable license types available to creators is a non-limited license priced based upon the enterprise licensee organization size. The organization size may be based on employees, revenue, or other business metrics. Alternatively, the enterprise user may make a license offer to the creator, and the content creator can accept or make a counteroffer. Once the license terms are agreed upon, the enterprise user pays into the enterprise user application for media licensing 1016 and may download the licensed media 1018. As previously mentioned, the license media may include one or more files and include the reproduction-centric metadata, certificates, and watermarks produced by the media oracle. The content creator thereafter receives licensing royalty from the creator application 1020.

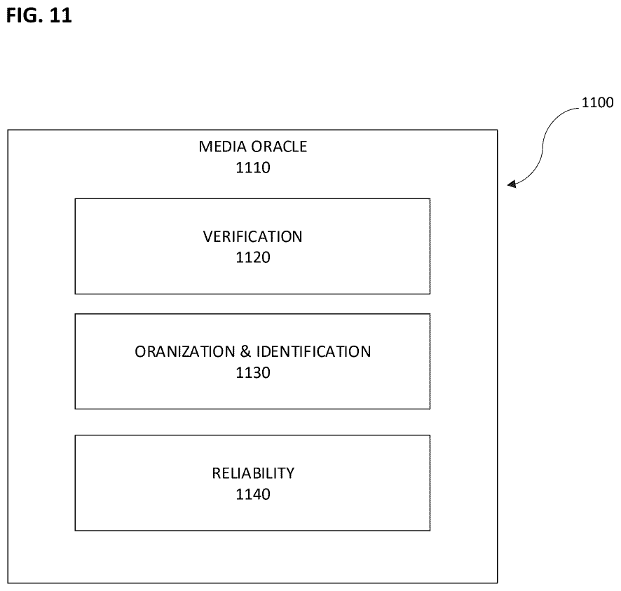

FIG. 11 depicts a schematic container of a media oracle 1100. As previously described in preceding embodiments, the media oracle 1110 is responsible for verification 1120, organization and identification 1130, and reliability 1140 of user-generated content uploaded to the verified media server database. The oracle may can be software, hardware, or human. In one embodiment of the present disclosure, the media oracle is a software-based oracle and programmed to parse text and third-party databases to verifying creator verification inputs, or creator credentials. In the verification container 1120, the mobile media oracle parses the content creator credentials produced by the previously discussed verification methods using documentation and information such as a creator's phone number, email, driver's license, IP address, organization ID, social security number, tax ID, or passport. Organization IDs may include identification such as press passes, cage codes, or other form of corporate/entity IDs such as employee badges or school IDs. The documentation and information for verification of creator credentials may be verified using photo-verification, third-party reporting agencies such as state and federal government e-licensing platforms, and other data sources either manually or automatically by the media oracle. In the organization and identification container 1130 of the mobile media oracle, user-generated content metadata from the camera application on the creator device such as time, date, location, duration, resolution quality, and other metadata that may be available, may be combined with the creator credential information including name, organization, and other information as available based on creator input and permissions is combined into reproduction-centric metadata associated with the content capture on the camera application. Additionally, the mobile media oracle may generate, through artificial intelligence methods, information including a title, tags, categories, events, and description. The artificial intelligence methods used by the media oracle to generate identifiers may rely on tags and other identifiers of other user-generated content in the proximity of a creator when capturing content; known events in the vicinity of a creator; known landmarks and buildings in the proximity of a creator; city, state, and regions in the proximity of the creator; and image recognition techniques. In the reliability container of the media oracle 1140, authenticity of media may be assured by preventing or limiting editing of media within the creator application. In some embodiments, creators may upload media captured outside of the creator application, and the media oracle will designate such media so that it may be known to at least enterprise users that a lower level of verification was performed on the media.

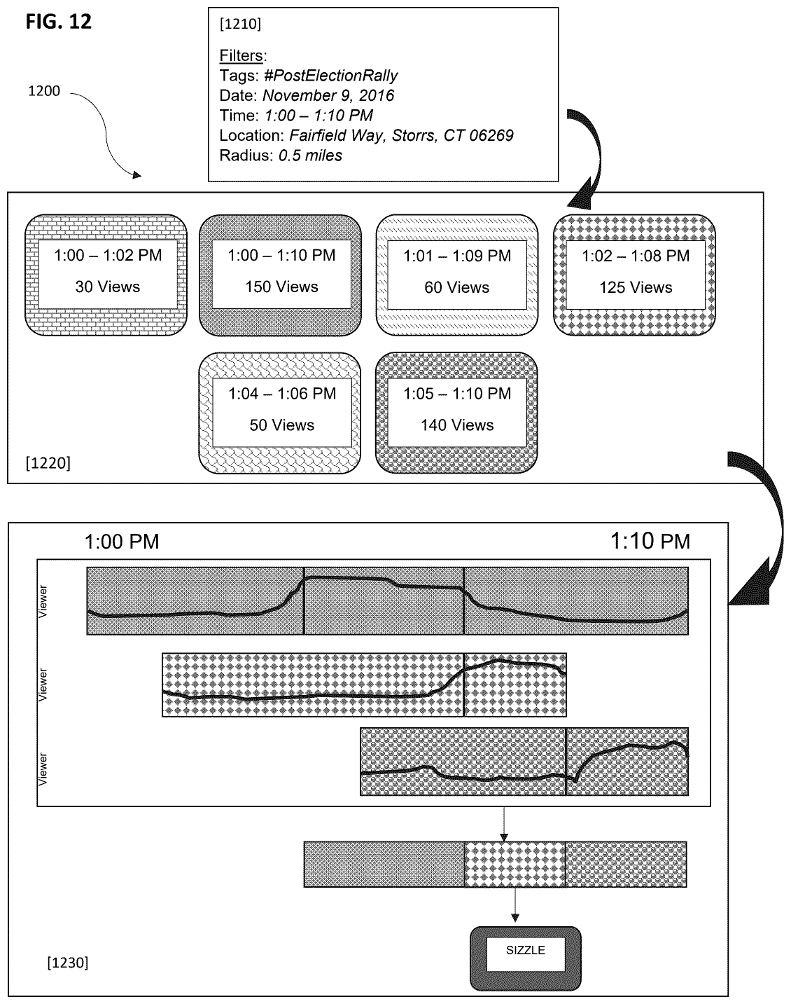

FIG. 12 is an example schematic process diagram that depicts the generation of mosaics 1220 and sizzles 1230 from either a hotspot on the geo-map or filters from the search function 1210. Mosaics are a collection of user-generated content based on specific search parameters including tags, date, time, location, and radius 1220. Mosaics may be various forms, including list views (with or without thumbnails), a plurality of icon views, full-screen navigable collections, or scrollable reels. As previously mentioned, thumbnails and icons for content may be generated and displayed according to the engagement information. Sizzles are algorithmically generated compilations of media from mosaics that show the most relevant portions of media stitched together in a single reel, or continuous feed 1230. According to the embodiment shown in FIG. 12, the sizzle 1230 is generated from a mosaic 1220 with six videos. The sizzle algorithm in this embodiment depicted starts by selecting the three videos with over one hundred views, cuts the videos according to their engagement and retention data, and stiches the three videos together into a single video reel. Engagement data may include integrations of view durations and counts over the time of the video. The algorithm may also use other AI-based methods which concern activity within a content stream such as audio activity or motion activity to generate sizzles.

What is claimed is:

1. A method for providing a verified media platform, comprising:
providing at least one creator device, at least one user device, and a verified media server in network communication;
executing, by the creator device, a creator application;
configuring the creator application to host a media oracle;
providing, by the creator device, creator credentials to the media oracle;
capturing a media source through a camera application hosted on the creator device;
processing, automatically, by the mobile media oracle, the media source into primary data and reproduction-centric metadata, wherein the reproduction-centric metadata is configured to include identifiers comprised of at least the creator credentials, geolocation, and a timestamp;
combining the primary data and the reproduction-centric metadata into one or more verified media files;
storing, by the verified media server, the verified media files into the verified media server database; and
organizing, by the verified media server processor, the verified media files into sets of data stored on the verified media server database according to the identifiers in the primary data and reproduction-centric metadata;
transmitting, by the verified media server processor, the verified media files to the user device.

2. The method of claim 1, wherein at least a portion of the reproduction-centric metadata is configurable based on input from a user.

3. The method of claim 1, wherein at least a portion of the reproduction-centric metadata is converted into a standardized, human-readable certificate.

4. The method of claim 1, wherein at least a portion of the reproduction-centric metadata is converted into a machine-readable watermark.

5. The method of claim 1, wherein the user device is configured to execute a user application configured to display verified media on a graphical user interface.

6. The method of claim 5, wherein the graphical user interface of the user application is configured to overlay the verified media on a geo-map, whereby verified media is represented in the form of hotspots; the hotspots having a spectrum density and radius generated based on the amount of verified media within a certain geo-spatial area; and the hotspots, when selected, configured to automatically display the verified media.

7. The method of claim 6, wherein there is a plurality of verified media associated with the hotspot, a sizzle is generated by the verified media server from the plurality of verified media.

8. The method of claim 6, wherein the graphical user interface is configured to display a list view window of the verified media embedded in the geo-map.

9. The method of claim 5, wherein the user application provides a searchable archive that provides for one or more of the following filter parameters: date, time of day, location, hashtag, campaign, creator, media type, media duration, media resolution, engagement thresholds, or rating.

10. The method of claim 8, wherein verified media server generates a sizzle from the verified media generated from a user search of the searchable archive.

11. A media system, comprising:
one or more verified media servers including at least one processor, at least one database, and configured to communicate with at least one creator device and at least one user device over a network via an application programming interface,
the media server database comprised of a computer-readable medium for storing media and instructions which, when executed by the processor of the media server, cause the server to perform operations, the operations comprising:
obtaining a plurality of media files, verified by a media oracle, from the creator device, wherein the media files are comprised of primary data and reproduction-centric metadata, the reproduction-centric metadata configured to include identifiers including creator credentials, geolocation, and timestamp;
storing the media files in the database according to the identifiers;
transmitting one or more of media files to at least one user device, wherein the media files are selected by the verified media server according to information received from the user device including user geolocation, user search parameters and filters, and user profile;
the user device configured to receive one or more media files, wherein the media files are displayed on a graphical user interface including a geo-map window,
the geo-map window configured to overlay media as an individual-selectable element or a collectively selectable element depending on the amount of media received at a particular location on the geo-map, wherein the collectively selectable element is configured as a spectrum that is scaled based on the media density in the area.

12. A method for distributing verified media, comprising:
receiving verified media, by a verified media server, from a creator device configured to execute a media oracle hosted in a creator application, wherein the verified media is comprised of primary data and reproduction-centric metadata;
generating, automatically, by a verified media exchange hosted on the verified media server, a license term for the media;
storing the verified media and associated license term, by the verified media server;
transmitting, by a user device, a request to license the verified media to the verified media server;
receiving the request to license by the verified media exchange hosted on the verified media server, the verified media exchange configured to:
evaluate the license request received by the user device and automatically generate a license for the media; and
transmitting, by the verified media exchange, the license generated by the verified media exchange and the verified media to the user device for download.

13. The method of claim 12, wherein at least a portion of the reproduction-centric metadata and licensing terms are converted into a standardized, human-readable certificate.

14. The method of claim 12, wherein the at least a portion of the reproduction-centric metadata is converted into a machine-readable watermark.
